(19) United States
(12) Patent Application Publication
(10) Pub. No.: US 2026/0053698 A1
(43) Pub. Date: Feb. 26, 2026

(54) MASSAGE DEVICE WITH SYMMETRICAL MOTOR ARRANGEMENT

(71) Applicant: HYPERICE IP SUBCO, LLC, Irvine, CA (US)

(72) Inventor: Bostjan Buc, Sostanj (SI)

(21) Appl. No.: 19/330,289

(22) Filed: Sep. 16, 2025

Related U.S. Application Data
(63) Continuation of application No. PCT/EP2024/057172, filed on Mar. 18, 2024.

(30) Foreign Application Priority Data
Mar. 17, 2023 (EP) 23162635

(51) Int. Cl. A61H 23/00

(52) U.S. Cl. CPC A61H 23/006; A61H 2201/1215; A61H 2201/14; A61H 2201/1454; A61H 2201/1669

(57) ABSTRACT

A massage device (1) comprises a motor (17), a piston (9), and a linkage (19). The piston (9) is configured to be driven by the motor (17) to carry out a reciprocating motion along a massage direction (11). The linkage (19) is configured to transfer a driving force from the motor (17) to the piston (9). The motor (17) comprises an output shaft (29) rotating about a shaft rotation axis (23) and having a first shaft portion (31) protruding from a first side of the motor (17) and a second shaft portion (33) protruding from an opposing second side of the motor (17). The linkage (19) connects both the first shaft portion (31) and the second shaft portion (33) to the piston (9).

### CROSS-REFERENCE TO RELATED APPLICATIONS

This application is a continuation of International (PCT) Patent Application No. PCT/EP2024/057172, filed on Mar. 18, 2024, which claims the benefit of, and priority to, European Application No. 23162635, filed on Mar. 17, 2023, each of which is incorporated herein by reference in its entirety.

### TECHNICAL FIELD

The invention relates to a massage device having a motor driving a piston for a reciprocating motion along a massage direction.

### BACKGROUND

U.S. Pat. No. 10,314,762 B1 discloses a battery-powered percussive massage device. A piston, to which an applicator head is coupled, is located within a cylindrical bore of an enclosure of the device and constrained to move only along a longitudinal axis of the cylindrical bore. A motor of the device has a shaft with a central axis perpendicular to the longitudinal axis of the cylindrical bore. A crank is coupled to the shaft and includes a pivot offset from the central axis of the shaft. A first end of a reciprocating linkage is coupled to the pivot of the crank and a second end of the reciprocating linkage is coupled to the piston.

EP 3 944 849 A1 discloses a double-head fascia massager comprising two pistons provided in different nozzles fixed to a housing of the device. Two massage heads are connected to the different pistons. A motor drives a rotating shaft protruding from both sides of the motor. Two sets of transmissions are arranged on the rotating shaft on both sides of the motor with the pistons being connected with the transmissions on the same side. The two sets of transmissions drive the two pistons to reciprocate in a staggered manner so that the massage heads reciprocate in a staggered manner.

There is a need to provide an efficient way of driving movable parts of a massage device. There is a need to provide a way of reducing wear in a massage device. There is a need for space efficient arrangement of parts of a massage device.

### SUMMARY

According to a first aspect of the invention, there is provided a massage device. The massage device comprises a motor, a piston and a linkage. The piston is configured to be driven by the motor to carry out a reciprocating motion along a massage direction. The linkage is configured to transfer a driving force from the motor to the piston. The motor comprises an output shaft. The output shaft rotates about a shaft rotation axis. The output shaft has a first shaft portion and a second shaft portion. The first shaft portion protrudes from a first side of the motor. The second shaft portion protrudes from a second side of the motor. The second side of the motor is opposite of the first side of the motor. The linkage connects both the first shaft portion and the second shaft portion to the piston.

There may be a first connection between the linkage and the first shaft portion. There may be a second connection between the linkage and the second shaft portion. By providing a first connection between the linkage and the first shaft portion and a second connection between the linkage and the second shaft portion, a load on an individual one of the connections may be reduced, as compared to a situation where an individual connection is reduced, in particular as compared to devices having only a single connection between the output shaft and the linkage.

The linkage may be driven by the first shaft portion and the second shaft portion. The linkage may be simultaneously driven by the first shaft portion and the second shaft portion. The motor may drive the linkage via both the first shaft portion and the second shaft portion so that the linkage carries out a linkage motion. The linkage may be configured to transfer a driving force from both the first shaft portion and the second shaft portion to the piston.

The linkage may be driven on the first side of the motor by the first shaft portion. The linkage may be driven on the second side of the motor by the second shaft portion.

A driving power transferred from the first shaft portion to the linkage may be at least essentially the same as a driving power transferred from the second shaft portion to the linkage.

A driving force from the motor may be transferred to the piston via two opposing sides of the motor, thereby avoiding or reducing one-sided load on one or more of the motor, the linkage, and the piston. One-sided load may increase wear of components and interfere with stable and efficient operation. Transferring driving force from opposing sides of the motor may facilitate providing a symmetrical transfer of force from the motor to the piston. There may be only radial load on motor bearings.

The shaft rotation axis may be perpendicular to the massage direction.

The first shaft portion and the second shaft portion may be coaxial with each other. The first shaft portion and the second shaft portion may be coaxial with the shaft rotation axis. The output shaft including the first shaft portion and the second shaft portion may be integrally formed. The output shaft including the first shaft portion and the second shaft portion may be a one-piece component.

A shape of the linkage may be symmetrical with respect to a plane parallel to the massage direction and perpendicular to the shaft rotation axis. A symmetrical linkage may reduce or avoid undesired forces, such as cross-forces, or one-sided loads.

There may be a first force transmission path from the first shaft portion to the piston and a second force transmission path from the second shaft portion to the piston. The first force transmission path and the second force transmission path may be symmetrical to each other, in particular symmetrical with respect to a plane parallel to the massage direction and perpendicular to the shaft rotation axis.

The motor may be an electric motor. The motor may comprise a rotor coil. The motor may comprise a stator coil. The motor may comprise one or both of a rotor coil and a stator coil.

The motor and the piston may be arranged one behind the other along the massage direction. The motor may be provided centrally behind the piston with respect to the massage direction. An arrangement of the motor behind the piston may facilitate symmetrical or even force transfer from the motor to the piston. Arranging the motor behind the piston may stabilize moving parts of the massage device, such as the linkage and the piston. Arranging the motor behind the piston may lead to a reduced requirement for space in directions perpendicular to the massage direction.

A virtual center axis of the piston along the massage direction may intersect at least one of a rotor coil and a stator coil of the motor. The virtual center axis of the piston may be parallel to the massage direction. A projection of the piston in parallel to the massage direction may overlap with the motor or extend through the motor.

A virtual axis parallel to the massage direction may extend through the piston and through the motor. A virtual axis parallel to the massage direction may extend through the piston and through at least one of a rotor coil a stator coil of the motor. The virtual axis may extend centrally through one or both of the piston and the motor.

The linkage may comprise a first arm and a second arm. The first arm may be connected to the first shaft portion. The second arm may be connected to the second shaft portion. The first arm and the second arm may extend in parallel to each other. The first arm and the second arm may extend in parallel to the massage direction. The motor may drive the first arm and the second arm for moving in a plane perpendicular to the shaft rotation axis and/or parallel to the massage direction.

The motor may be at least partially sandwiched between the first arm and the second arm. The motor may be provided at least partially between the first arm and the second arm with respect to a direction parallel to the shaft rotation axis. The motor may be compactly arranged between the first arm and the second arm. The first arm may be provided at the first side of the motor. The second arm may be provided at the second side of the motor.

The linkage may comprise a first part and a second part. The first part may comprise at least the first arm. The second part may comprise at least the second arm. The first part and the second part may be separate parts that are fixed to each other. The first part and the second part may be fixed to each other by a fixing element, such as a screw or a bolt, for example. The first arm and the second arm of the linkage may be rigidly connected. The first part and the second part of the linkage may be rigidly connected. Providing the first part and the second part as separate parts may facilitate assembly of the massage device. A connection between the first shaft portion and the first part and a connection between the second shaft portion and the second part may be established before fixing the first part and the second part of the linkage to each other.

The linkage may comprise one or more injection molded parts. The first part may be an injection molded part. The second part may be an injection molded part.

The linkage may be connected to the first shaft portion by a first eccentric. The first eccentric may be shaped as a disk, in particular as a disk eccentrically arranged at the first shaft portion. The disk may be connected to, mounted at or integrally formed with the first shaft portion. The linkage may be connected to the second shaft portion by a second eccentric. The second eccentric may be shaped as a disk, in particular as a disk eccentrically arranged at the second shaft portion. The disk may be connected to, mounted at or integrally formed with the second shaft portion. The first arm may be connected to the first shaft portion by the first eccentric. The second arm may be connected to the second shaft portion by the second eccentric. The first eccentric and the second eccentric may be aligned with each other such that the first arm and the second arm of the linkage move in concert. The first arm and the second arm of the linkage may move in phase with each other.

The shaft rotation axis may extend through the first eccentric. The shaft rotation axis may extend through the second eccentric. The shaft rotation axis extending through one or both of the first eccentric and the second eccentric may provide increased stability of the arrangement including the motor, the output shaft and the linkage.

A first bearing may be provided between the first eccentric and the linkage, in particular between the first eccentric and the first arm of the linkage. The first eccentric may be configured to rotate within the first bearing. The first bearing may extend around the first eccentric.

The first bearing may be provided in the linkage, in particular in a first bearing recess provided in the linkage. The first eccentric may be provided in the linkage, in particular in a first bearing recess provided in the linkage. The first bearing and the first eccentric may be provided in the linkage, in particular in a first bearing recess provided in the linkage. One or both of the first bearing and the first eccentric may be provided in the first arm of the linkage. The first bearing recess may be provided in the first arm of the linkage. The first bearing recess may be open to only one side, the only one side preferably being a side facing the motor.

A second bearing may be provided between the second eccentric and the linkage, in particular between the second eccentric and the second arm of the linkage. The second eccentric may be configured to rotate within the second bearing. The second bearing may extend around the second eccentric.

The second bearing may be provided in the linkage, in particular in a second bearing recess provided in the linkage. The second eccentric may be provided in the linkage, in particular in a second bearing recess provided in the linkage. The second bearing and the second eccentric may be provided in the linkage, in particular in a second bearing recess provided in the linkage. One or both of the second bearing and the second eccentric may be provided in the second arm of the linkage. The second bearing recess may be provided in the second arm of the linkage. The second bearing recess may be open to only one side, the only one side preferably being a side facing the motor.

The first bearing may be a roller bearing. The second bearing may be a roller bearing.

The first bearing may extend around the shaft rotation axis. The second bearing may extend around the shaft rotation axis. One or both of the first bearing and the second bearing extending around the shaft rotation axis may provide increased stability of the arrangement including the motor, the output shaft and the linkage.

The first eccentric may rotate within the first bearing about a first bearing axis. The first bearing axis may revolve around the shaft rotation axis. The second eccentric may rotate within the second bearing about a second bearing axis. The second bearing axis may revolve around the shaft rotation axis. One or both of the first bearing axis and the second bearing axis may be parallel to the shaft rotation axis.

One or both of the first bearing and the second bearing may be a low profile bearing. One or both of the first bearing and the second bearing may have a height in a direction parallel to the shaft rotation axis between 3 millimeters and 18 millimeters, or between 5 millimeters and 14 millimeters, for example.

Since the linkage connects both the first shaft portion and the second shaft portion to the piston, there may be a reduced axial load on one or both of the first bearing and the second bearing and reduced axial load on motor bearings.

The linkage may be rotatably attached to the piston. A connection between the linkage and the piston may allow rotation about a link rotation axis. The link rotation axis may be parallel to the shaft rotation axis. The link rotation axis may be perpendicular to the massage direction.

The linkage may comprise a link portion. The link portion may be connected to the piston. The link portion may be rotatably connected to the piston. A connection between the link portion and the piston may allow rotation about the link rotation axis. The link portion may be rigidly connected to the first arm and the second arm of the linkage. A first part of the link portion may be integrally formed with the first arm of the linkage. The first part of the link portion and the first arm may together form the first part of the linkage. A second part of the link portion may be integrally formed with the second arm of the linkage. The second part of the link portion and the second arm may together form the second part of the linkage.

The link portion may be received within the piston. A connection between the link portion and the piston may be protected within the piston. Providing the link portion within the piston may allow reducing a distance between the motor and the piston along the massage direction.

The linkage, in particular the link portion of the linkage, may be connected to the piston by a pin connection. The pin connection may allow rotation about a link rotation axis parallel to the shaft rotation axis. The pin connection may comprise a pin extending at least partially through the piston and the linkage. The piston may comprise a piston opening. The linkage, in particular the link portion of the linkage, may comprise a linkage opening. The piston opening and the linkage opening may be coaxially arranged. The pin may be received in the piston opening and the linkage opening. The pin may extend through the piston opening and the linkage opening.

The linkage may be essentially Y-shaped.

The piston may comprise a sleeve and an inner part. The inner part may be at least partially received in the sleeve. The inner part and the sleeve may be formed of different materials. For example, the inner part may comprise a plastic material or may be formed of a plastic material. The inner part may be an injection molded part. A material of the sleeve may have a higher hardness than a material of the inner part. For example, the sleeve may be a metal part. The sleeve, may, for example, be a machined metal part.

The massage device may comprise a bushing. The bushing may be stationary with respect to a housing of the massage device. The piston may be guided in the bushing for the reciprocating motion along the massage direction.

The sleeve of the piston may be configured to engage the bushing to be guided by the bushing. The sleeve of the piston may comprise an outer surface that forms a guide surface for engaging an inner surface of the bushing. The guide surface of the sleeve of the piston may be wear resistant.

The link portion of the linkage may be within the bushing during an entire stroke of the piston. The bushing may be configured to stabilize the reciprocating motion of the piston.

The inner part of the piston and the sleeve of the piston may be fixed to each other by one or more fixing elements. The one or more fixing elements may comprise one or more screws, for example.

The linkage, in particular the link portion of the linkage, may be rotatably connected to the inner part of the piston.

The link portion may be received within the inner part of the piston.

The motor may comprise a flywheel. The flywheel may comprise a counterweight. A weight distribution of the flywheel may optionally be asymmetrical with respect to the shaft rotation axis. The flywheel may be placed within motor bearings of the motor. A flywheel placement within motor bearings may lead to a reduced load on motor bearings of the motor. The flywheel may increase a motor inertia of the motor. The flywheel may allow providing the motor with a reduced stack height in a direction parallel to the shaft rotation axis. The flywheel may lead to an increased motor diameter in a radial direction perpendicular to the shaft rotation axis. An increased motor diameter in a radial direction perpendicular to the shaft rotation axis may lead to a constant output torque.

The flywheel may be at least partially sandwiched between the first arm and the second arm of the linkage. Along the shaft rotation axis, the flywheel may be provided between the first shaft portion and the second shaft portion.

The flywheel may be integrated within a rotor bell of the motor.

According to a second aspect of the invention, there is provided a method for operating a massage device. A force is transmitted from a first shaft portion of an output shaft of a motor of a massage device and a second shaft portion of the output shaft of the motor to a piston of the message device, thereby causing the piston to carry out a reciprocating motion along a massage direction. The first shaft portion protrudes from a first side of the motor and the second shaft portion protrudes from a second side of the motor.

The force may be transmitted by a linkage. The linkage may be essentially Y-shaped.

According to a third aspect of the invention, there is provided a use of two output shaft portions protruding from opposite sides of a motor for driving a piston of a massage device into a reciprocating motion along a massage direction. The two output shaft portions may be part of an output shaft of the motor. The two output shaft portions may be formed integrally with the output shaft of the motor.

The two output shaft portions may be used to obtain a symmetrical transfer of forces from the motor to the piston.

According to a fourth aspect of the invention, there is provided a massage device. The massage device comprises an electric motor and a piston. The piston is configured to be driven by the electric motor to carry out a reciprocating motion along a massage direction. A virtual center axis of the piston along the massage direction intersects at least one of a rotor coil or a stator coil of the electric motor.

According to a fifth aspect of the invention, there is provided a method for operating a massage device. An electric motor is operated to drive a piston of the massage device to carry out a reciprocating motion along a massage direction. A virtual center axis of the piston along the massage direction intersects at least one of a rotor coil or a stator coil of the electric motor.

A force may be transmitted from both a first shaft portion of an output shaft of the motor and a second shaft portion of the output shaft of the motor to the piston.

According to a sixth aspect of the invention, a massage device is provided. The massage device comprises a motor, a piston and a linkage. The piston is configured to be driven by the motor to carry out a reciprocating motion along a massage direction. The linkage is configured to transfer a driving force from the motor to the piston. The piston comprises a sleeve and an inner part at least partially received in the sleeve.

The inner part and the sleeve may be formed of different materials. For example, the inner part may comprise a plastic material or may be formed of a plastic material. The inner part may be an injection molded part. A material of the sleeve may have a higher hardness than a material of the inner part. For example, the sleeve may be a metal part. The sleeve, may, for example, be a machined metal part.

The inner part of the piston and the sleeve of the piston may be fixed to each other by one or more fixing elements. The one or more fixing elements may comprise one or more screws, for example.

The massage device may comprise a bushing. The bushing may be stationary with respect to a housing of the massage device. The piston may be guided in the bushing for the reciprocating motion along the massage direction.

The sleeve of the piston may be configured to engage the bushing to be guided by the bushing. The sleeve of the piston may comprise an outer surface that forms a guide surface for engaging an inner surface of the bushing. The guide surface of the sleeve may be wear resistant.

The linkage, in particular a link portion of the linkage, may be rotatably attached to the piston, in particular to the inner part of the piston. A connection between the linkage and the piston may allow rotation about a link rotation axis. The link rotation axis may be perpendicular to the massage direction.

The link portion of the linkage may be within the bushing during an entire stroke of the piston.

The link portion may be received within the piston, in particular within the inner part of the piston. A connection between the link portion and the piston may be protected within the piston. Providing the link portion within the piston may allow reducing a distance between the motor and the piston along the massage direction.

According to a seventh aspect of the invention, a method for operating a massage device is provided. A force is transmitted from a motor of a massage device to a piston of the massage device by a linkage, thereby causing the piston to carry out a reciprocating motion along a massage direction. The piston is guided in a bushing of the massage device for the reciprocating motion along the massage direction. A sleeve of the piston engages the bushing to be guided by the bushing. An inner part of the piston received in the sleeve is connected to the linkage.

According to an eighth aspect of the invention, a massage device is provided. The massage device comprises a motor, a piston and a linkage. The piston is configured to be driven by the motor to carry out a reciprocating motion along a massage direction. The linkage is configured to transfer a driving force from the motor to the piston. The motor comprises a first shaft portion and a second shaft portion rotating about a shaft rotation axis. The first shaft portion protrudes from a first side of the motor. The second shaft portion protrudes from a second side of the motor. The second side of the motor is opposite of the first side of the motor. The linkage connects both the first shaft portion and the second shaft portion to the piston. The massage device further comprises a first eccentric connecting the linkage to the first shaft portion. The first eccentric is provided in the linkage. The massage device further comprises a second eccentric connecting the linkage to the second shaft portion. The second eccentric is provided in the linkage. The shaft rotation axis extends through the first eccentric and the second eccentric.

The first eccentric may be shaped as a disk, in particular as a disk eccentrically arranged at the first shaft portion. The second eccentric may be shaped as a disk, in particular as a disk eccentrically arranged at the second shaft portion.

The linkage may comprise a first arm and a second arm. The first arm may be connected to the first shaft portion by the first eccentric. The second arm may be connected to the second shaft portion by the second eccentric. The first eccentric and the second eccentric may be aligned with each other such that the first arm and the second arm of the linkage move in concert. The first arm and the second arm of the linkage may move in phase with each other.

The first eccentric may be provided in a first bearing recess provided in the linkage. The second eccentric may be provided in a second bearing recess provided in the linkage. The first bearing recess may be open to only one side, the only one side preferably being a side facing the motor. The second bearing recess may be open to only one side, the only one side preferably being a side facing the motor.

A first bearing may be provided between the first eccentric and the linkage, in particular between the first eccentric and the first arm of the linkage. The first eccentric may be configured to rotate within the first bearing. The first bearing may extend around the first eccentric.

The first bearing may be provided in the linkage, in particular in a first bearing recess provided in the linkage. The first bearing and the first eccentric may be provided in the linkage, in particular in a first bearing recess provided in the linkage. One or both of the first bearing and the first eccentric may be provided in the first arm of the linkage. The first bearing recess may be provided in the first arm of the linkage.

A second bearing may be provided between the second eccentric and the linkage, in particular between the second eccentric and the second arm of the linkage. The second eccentric may be configured to rotate within the second bearing. The second bearing may extend around the second eccentric.

The second bearing may be provided in the linkage, in particular in a second bearing recess provided in the linkage. The second eccentric may be provided in a second bearing recess pro-vided in the linkage. The second bearing and the second eccentric may be provided in the linkage, in particular in a second bearing recess provided in the linkage. One or both of the second bearing and the second eccentric may be provided in the second arm of the linkage. The second bearing recess may be provided in the second arm of the linkage.

The first bearing may be a roller bearing. The second bearing may be a roller bearing.

The first bearing may extend around the shaft rotation axis. The second bearing may extend around the shaft rotation axis. One or both of the first bearing and the second bearing extending around the shaft rotation axis may provide increased stability of the arrangement including the motor, the output shaft and the linkage.

The first eccentric may rotate within the first bearing about a first bearing axis. The first bearing axis may revolve around the shaft rotation axis. The second eccentric may rotate within the second bearing about a second bearing axis. The second bearing axis may revolve around the shaft rotation axis. One or both of the first bearing axis and the second bearing axis may be parallel to the shaft rotation axis.

According to a ninth aspect of the invention, there is provided a method for operating a massage device. A force is transmitted by a linkage from a first shaft portion of a motor of the massage device and a second shaft portion of the motor to a piston of the message device, thereby causing the piston to carry out a reciprocating motion along a massage direction. The first shaft portion protrudes from a first side of the motor and the second shaft portion protrudes from a second side of the motor. A first eccentric connecting the linkage to the first shaft portion rotates within the linkage. A second eccentric connecting the linkage to the second shaft portion rotates within the linkage. The first shaft portion and the second shaft portion rotate about a shaft rotation axis. The shaft rotation axis extends through the first eccentric and the second eccentric.

According to a tenth aspect of the invention, a massage device is provided. The massage device comprises a motor, a piston and a linkage. The piston is configured to be driven by the motor to carry out a reciprocating motion along a massage direction. The linkage is configured to transfer a driving force from the motor to the piston. The motor comprises a first shaft portion and a second shaft portion rotating about a shaft rotation axis. The first shaft portion protrudes from a first side of the motor. The second shaft portion protrudes from a second side of the motor. The second side of the motor is opposite of the first side of the motor. The linkage connects both the first shaft portion and the second shaft portion to the piston. The massage device further comprises a bushing. The piston is guided in the bushing for the reciprocating motion along the massage direction. The linkage comprises a link portion rotatably connected to the piston. The link portion of the linkage is within the bushing during an entire stroke of the piston.

The link portion may be received within the piston.

The linkage, in particular the link portion of the linkage, may be connected to the piston by a pin connection. The pin connection may allow rotation about a link rotation axis parallel to the shaft rotation axis. The pin connection may comprise a pin extending at least partially through the piston and the linkage.

According to an eleventh aspect of the invention, there is provided a method for operating a massage device. A force is transmitted by a linkage from a first shaft portion of a motor of the massage device and a second shaft portion of the motor to a piston of the message device, thereby causing the piston to carry out a reciprocating motion along a massage direction. The first shaft portion protrudes from a first side of the motor and the second shaft portion protrudes from a second side of the motor. The piston is guided in a bushing of the massage device for the reciprocating motion along the massage direction. The linkage comprises a link portion rotatably connected to the piston. The link portion of the linkage is within the bushing during an entire stroke of the piston.

Features, descriptions and explanations presented with respect to any of the aspects of the invention described herein may be combined with, applied to, or transferred to any of the other aspects described herein. The methods and the use described herein may be carried out with any of the massage devices described herein. The massage devices described herein may be suitable, or adapted, or configured to carry out any of the methods or the use described herein.

Any methods or uses described herein may be non-therapeutic. In particular, the methods or uses described herein may be merely recreational.

### BRIEF DESCRIPTION OF THE DRAWINGS

In the following, embodiments will be further described with reference to the figures.

FIG. 1 shows a schematic perspective view of a massage device according to an embodiment with the piston in a retracted position.

FIG. 2 shows a schematic perspective view of the massage device according to the embodiment with the piston in an extended position.

FIG. 3 shows a schematic perspective view of the massage device according to the embodiment with a part of the housing removed.

FIG. 4 shows a partial sectional view through the massage device according to the embodiment in a sectional plane parallel to the massage direction and the shaft rotation axis.

FIG. 5 shows a schematic perspective view of a linkage of the massage device according to the embodiment.

FIG. 6 shows a schematic perspective view of the piston of the massage device according to the embodiment in an exploded view.

### DETAILED DESCRIPTION

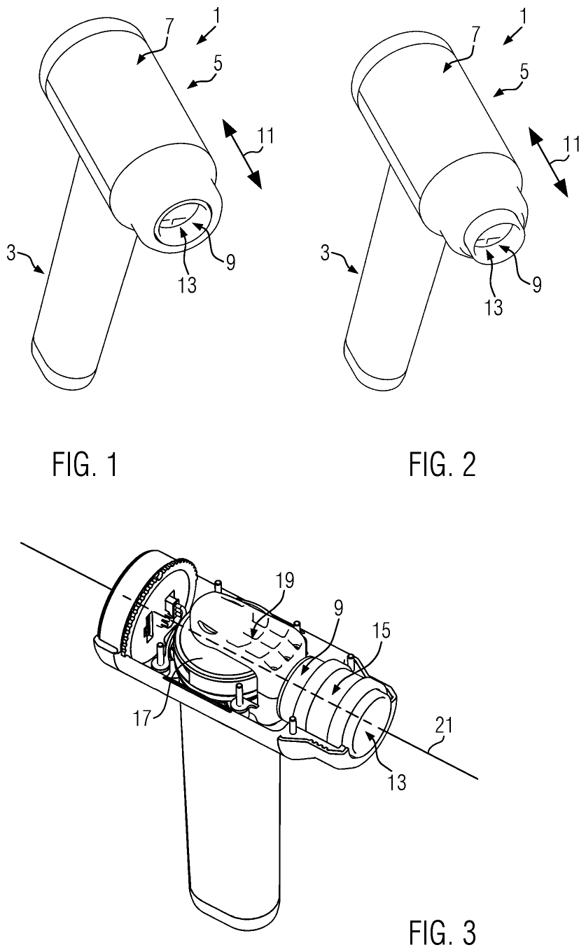

FIG. 1 shows a massage device 1. The massage device 1 comprises a handle portion 3 and a main body portion 5. A housing 7 defines an outer appearance of the massage device 1. The housing 7 comprises an opening through which an end section of a piston 9 of the massage device 1 can be seen in FIG. 1. The piston 9 is configured to carry out a reciprocating motion along a massage direction 11. In FIG. 1, the piston 9 is in a retracted position. The retracted position corresponds to a position in which the piston 9 is most retracted into the main body portion 5 during the reciprocating motion along the massage direction 11. FIG. 2 shows the massage device 1 with the piston 9 in an extended position. The extended position corresponds to a position of the piston 9 during the reciprocating motion along the massage direction 11 where the piston 9 is extended furthest out of the main body portion 5.

At the end of the piston 9 that faces towards an outside of the massage device 1, a receiving recess 13 is provided. A mounting portion of a massage applicator may be inserted into the receiving recess 13 to mount the massage applicator to the massage device 1. The massage applicator is configured for contact with a massage recipient. Alternatively, the massage applicator and the piston 9 may be formed as a one-piece-structure or may be fixatedly connected to each other.

FIG. 3 shows the massage device 1 with a part of the housing 7 removed. The massage device 1 comprises a bushing 15 surrounding the piston 9 and guiding the piston 9 for the reciprocating motion along the massage direction 11. In the illustrated embodiment, the bushing 15 does not extend over the full length of the piston 9 along the massage direction 11. This may reduce friction between the piston 9 and the bushing 15.

The massage device 1 comprises a motor 17 with a flywheel 18. The motor 17 drives the piston 9 for the reciprocating motion along the massage direction 11. A linkage 19 transfers a driving force from the motor 17 to the piston 9. The motor 17 is provided behind the piston 9 with respect to the massage direction 11. A center axis 21 of the piston 9 extends in parallel to the massage direction 11 and intersects the motor 17.

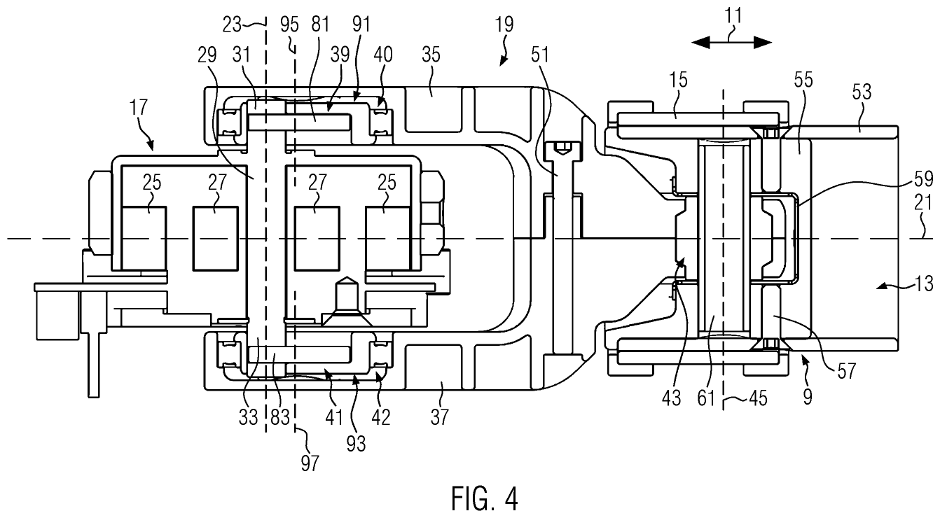

FIG. 4 shows a sectional view of the massage device 1 in a sectional plane parallel to the massage direction 11 and to a shaft rotation axis 23. For ease of understanding, various components of the massage device 1 are not illustrated in FIG. 4, such as the housing 7, for example. The motor 17 is formed as an electric motor 17 comprising one or more rotor coils 25 and one or more stator coils 27, which are illustrated schematically in FIG. 4. The center axis 21 of the piston 9 extends through the rotor coils 25 and the stator coils 27. The motor 17 comprises an output shaft 29 rotating about the shaft rotation axis 23. The shaft rotation axis 23 is perpendicular to the massage direction 11. The output shaft 29 comprises a first shaft portion 31 protruding from a first side of the motor 17 and a second shaft portion 33 protruding from a second side of the motor 17 opposite of the first side of the motor 17. The first shaft portion 31 and the second shaft portion 33 rotate about the shaft rotation axis 23 in unison.

The linkage 19 comprises a first arm 35 and a second arm 37. The motor 17 is partially sandwiched between the first arm 35 and the second arm 37. The first arm 35 is connected to the first shaft portion 31 at the first side of the motor 17 by a first eccentric 39. The second arm 37 is connected to the second shaft portion 33 at the second side of the motor 17 by a second eccentric 41. A first pin 81 extending perpendicular to the shaft rotation axis 23 connects the first eccentric 39 to the first shaft portion 31. A second pin 83 extending perpendicular to the shaft rotation axis 23 connects the second eccentric 41 to the second shaft portion 33. A first bearing 40 is provided between the first eccentric 39 and the first arm 35. The first eccentric 39 rotates within the first bearing 40 about a first bearing axis 95. The first bearing 40 and the first eccentric 39 are received in a first bearing recess 91 provided in the first arm 35 of the linkage 19. A second bearing 42 is provided between the second eccentric 41 and the second arm 37. The second eccentric 41 rotates within the second bearing 42 about a second bearing axis 97. The second bearing 42 and the second eccentric 41 are received in a second bearing recess 93 provided in the second arm 37 of the linkage 19. The shaft rotation axis 23 extends through the first eccentric 39 and the second eccentric 41. The first bearing 40 and the second bearing 42 extend around the shaft rotation axis 23.

The linkage 19 further comprises a link portion 43 rotatably connected to the piston 9 about a link rotation axis 45.

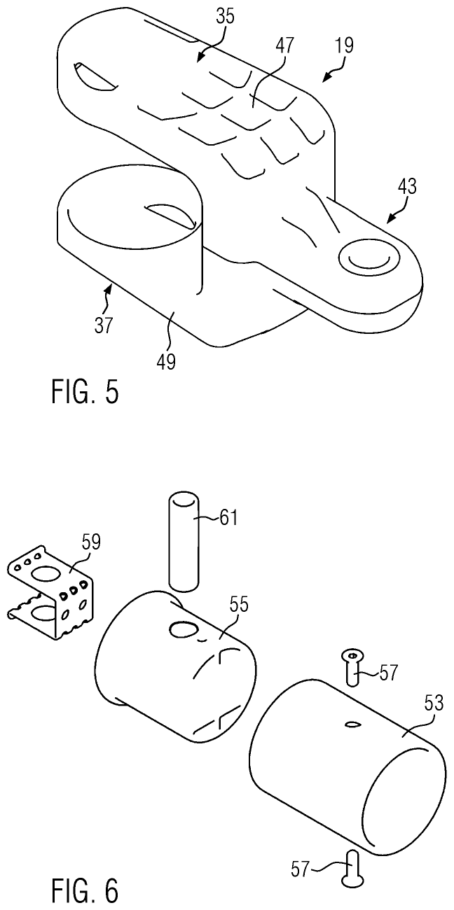

As shown in FIG. 5, the linkage 19 is generally Y-shaped with the first arm 35, the second arm 37 and the link portion 43. The linkage 19 comprises a first part 47 and a second part 49. The first part 47 comprises the first arm 35 and a first link part of the link portion 43. The second part 49 comprises the second arm 37 and a second link part of the link portion 43. As shown in FIG. 4, the first part 47 and the second part 49 of the linkage 19 are combined by a fixing element 51, which may be a bolt or a screw, for example.

As shown in FIG. 4, the piston 9 comprises a sleeve 53 and an inner part 55 received within the sleeve 53. In a direction away from the motor 17, the sleeve 53 protrudes beyond the inner part 55, thereby forming the receiving space 13 for receiving the massage applicator. The sleeve 53 and the inner part 55 are fixed to each other by fixing elements 57 in the form of screws. The sleeve 53 forms a guide surface of the piston 9 engaging an inner surface of the bushing 15 to guide the piston 9 along the massage direction 11.

As shown in FIG. 4, the inner part 55 of the piston 9 comprises a receiving opening in which the link portion 43 of the linkage 19 is provided. An inner surface of the receiving opening is lined by a bracket 59 of the piston 9. The inner part 55 and the bracket 59 of the piston 9 and the link portion 43 of the linkage 19 each comprises an opening. The openings are arranged coaxially along the link rotation axis 45. A pin 61 extends through the openings to rotatably connect the link portion 43 of the linkage 19 to the piston 9. The pin 61 is surrounded by the bushing 15 during an entire stroke of the piston 9.

FIG. 6 shows exploded view of the piston 9 including the pin 61.

During operation, the output shaft 29 of the motor 17 rotates about the shaft rotation axis 23. This leads to a motion of the linkage 19, which in turn moves the piston 9 to reciprocate along the massage direction 11, while being guided by the bushing 15. During operation, a driving force is transferred from the output shaft 23 to the linkage 19 via the first eccentric 39 and the first arm 35 and via the second eccentric 41 and the second arm 37. The linkage 19 transfers the driving force to the piston 9 so that the piston 9 reciprocally moves along the massage direction 11.

1. A massage device, comprising:
a motor;
a piston configured to be driven by the motor to carry out a reciprocating motion along a massage direction; and
a linkage configured to transfer a driving force from the motor to the piston;
wherein the motor comprises an output shaft rotating about a shaft rotation axis and having a first shaft portion protruding from a first side of the motor and a second shaft portion protruding from an opposing second side of the motor; and
wherein the linkage connects both the first shaft portion and the second shaft portion to the piston.

2. The massage device according to claim 1, wherein the linkage comprises a first arm connected to the first shaft portion and a second arm connected to the second shaft portion, wherein the linkage comprises a first part comprising the first arm, and a second part comprising the second arm, and wherein the first part and the second part are separate parts that are fixed to each other.

3. The massage device according to claim 1, further comprising a first eccentric connecting the linkage to the first shaft portion.

4. The massage device according to claim 3, wherein the first eccentric is shaped as a disk eccentrically arranged at the first shaft portion.

5. The massage device according to claim 3, wherein the first eccentric is provided in a first bearing recess provided in the linkage.

6. The massage device according to claim 3, wherein the shaft rotation axis extends through the first eccentric.

7. The massage device according to claim 3, further comprising a first bearing provided between the first eccentric and the linkage.

8. The massage device according to claim 7, wherein first bearing extends around the shaft rotation axis.

9. The massage device according to claim 7, wherein the first bearing is a roller bearing.

10. The massage device according to claim 1, wherein the linkage comprises one or more injection molded parts.

11. The massage device according to claim 1, wherein the linkage comprises a link portion connected to the piston, wherein the link portion is received within the piston.

12. The massage device according to claim 1, wherein the piston comprises a sleeve and an inner part at least partially received in the sleeve.

13. The massage device according to claim 1, further comprising a bushing, wherein the piston is guided in the bushing for the reciprocating motion along the massage direction, wherein the linkage comprises a link portion connected to the piston, wherein the link portion is within the bushing during an entire stroke of the piston.

14. The massage device according to claim 1, wherein the motor comprises a flywheel.

15. A method for operating a massage device, comprising:
using two output shaft portions of an output shaft of a motor for driving a piston of the massage device into a reciprocating motion along a massage direction, the two output shaft portions protruding from opposite sides of the motor.

16. A method for operating a massage device comprising:
transmitting a force from a first shaft portion of an output shaft of a motor of the massage device and a second shaft portion of the output shaft of the motor to a piston of the massage device, thereby causing the piston to carry out a reciprocating motion along a massage direction;
wherein the first shaft portion protrudes from a first side of the motor and the second shaft portion protrudes from a second side of the motor.
